(19) United States
(12) Patent Application Publication
(10) Pub. No.: US 2014/0360345 A1
(43) Pub. Date: Dec. 11, 2014

(54) TRANSPARENT CERAMIC MATERIAL

(71) Applicants: Lars Schnetter, Wimbach (DE); Frank Wittig, Erlangen (DE)

(72) Inventors: Lars Schnetter, Wimbach (DE); Frank Wittig, Erlangen (DE)

(73) Assignee: CERAMTEC-ETEC GMBH, Lohmar (DE)

(21) Appl. No.: 14/355,245

(22) PCT Filed: Nov. 7, 2012
(86) PCT No.: PCT/EP2012/072055

§ 371 Date: Apr. 30, 2014

(30) Foreign Application Priority Data
Nov. 7, 2011 (DE) 10 2011 085 868.7

(51) Int. Cl. F41H 5/02; C04B 35/443

(52) U.S. Cl. CPC F41H 5/02; C04B 35/443; C04B 2235/9653; C04B 2235/786
USPC 89/36.02; 423/600; 423/385

(57) ABSTRACT

A transparent ceramic material and the use thereof, wherein the transparent ceramic has an RIT>75%, measured on a 2 mm-thick, polished disk with light with a wave length of 600 nm, and average particle sizes in the range of >10 to =<100 micrometer, preferably >10 to 50 micrometer, more preferably >10 to 20 micrometer. The transparent ceramic material is, for example, Mg—Al spinel, ALON, aluminum oxide, yttrium aluminum garnet, yttrium oxide or zirconium oxide.

The subject matter of the present invention is a transparent ceramic material, a method for producing same and use thereof.

The invention relates to a transparent ceramic material of a high strength, which includes all transparent ceramic materials, for example, Mg-Al spinel, AlON, yttrium aluminum garnet, yttrium oxide, zirconium oxide, etc. Of particular interest here are the materials with an increased mechanical load-bearing capacity and especially safety in this case, such as protective ceramics, e.g., Mg—Al spinel, AlON, aluminum oxide, etc.

Motor vehicles, such as military vehicles or to some extent even civilian vehicles are often armor plated to protect them from gunshot. Armoring is usually done by using a metal or metal-ceramic system. However, such systems are impossible for areas containing windows, such as side windows, front windshields and the like. These areas are furnished with bulletproof glass, for example, but bulletproof glass is known to have a much lower ballistic efficiency than the composite or metal armor-plating systems with respect to hard-core ammunition. Consequently, the window areas equipped with bulletproof glass represent weak specks in a vehicle. An adequate protective effect can be achieved only with a very high weight, which definitely reduces the mobility of the vehicles and their load limits.

Transparent ceramics have an improved protective behavior in comparison with bulletproof glass. For this reason, there was a search for alternatives to bulletproof glass at a relatively early point in time. These alternatives were found essentially in ceramics such as spinel and AlON. These ceramics have improved mechanical properties in comparison with bulletproof glass such as increased strength and hardness. With the known ceramics, however, it is difficult to produce almost defect-free components in contrast with bulletproof glass. In most cases, large individual defects>100 μm in size are still to be found in components made of transparent ceramic. Examples of such defects include in particular pores due to pores in the starting powder for the transparent ceramics as well as granular relics, pressing defects, outgassing, organic inclusions and the like. These defects do not necessarily influence the transparency measurement but they are an obstacle to vision and are thus to be avoided. Inclusions such as those in pressing methods cannot be reliably prevented and they reduce the benefit of the ceramic material in particular when used as a transparent ceramic protective material. In addition, there is another effect:

In the International Journal of Impact Engineering, May 27, 2002, 509-520, it is reported that the HEL (Hugenostic elastic limit) is a crucial variable for the efficacy of ceramics in ballistic protection. In addition, it has been found that porosity has a strong influence on the HEL. Larger pores—in number and specific size—reduce the HEL and thus reduce the protective effect.

In Ceramic Engineering and Science Proceedings, 26:77, 2005, 123-130 it is reported that the porosity is relevant to the damage because it has been identified as a triggering factor for material flow and thus in the destruction of the ceramic.

In addition, it has been found that strength is an important parameter for the installation of panes of transparent ceramic in motor vehicles because a suitable strength is necessary due to mechanical stresses such as due to rock hits or torsion on the vehicle. Since there is a desire for relatively thin ceramic layers in general, a suitably high strength is desirable to be able to produce thin panes of glass. In other words, the strength of the entire component—usually in the form of individual tiles—is critically relevant for its use. In ceramic components, the largest defect is relevant for failure of the component, so a high strength in small individual tests does not provide adequate information.

A high four-point bending strength is a good measurable variable for characterizing a component. To fulfill higher strength requirements according to the invention, there must not be any major structural defect in the four-point bending tests so that the probability of corresponding defects being present in larger components is reduced. To fulfill the minimum requirement, no defect>100 μm in size should be present in the four-point bending test samples according to DIN EN 843-1 or, better yet, there should not be any defects>20 μm.

In developments so far, there have always been attempts to produce components with an increased strength. The MER Corporation in Tucson, Ariz., USA has produced a spinel with a four-point bending strength of approx. 300 MPa. In hot-pressed components, which are usually produced with the aid of LiF, the pores have a smooth surface, which promotes transparency, and thus they are not at a disadvantage visually. By means of microscopic analysis, however, it has been demonstrated that there are larger pores, and also the large crystals also have the effect of reducing strength due to the high process temperatures. The maximum four-point bending strength values are ≦300 MPa on the average (data from MER). The ceramics produced according to EP 1 557 402 A2 with grain sizes of <1 μm also seem to have elements that reduce strength because the strength values of 200-250 MPa reported there are even below the strength values of hot-pressed components. No information is provided about the size of individual inclusions, but the low strength leads to such inclusions because higher strength values can be measured even at grain sizes of ≧50 μm.

Strength values of around 400 MPa can be achieved by means of SPS (=spark plasma sintering) as described in “Condition Optimization for Producing Transparent MgAl₂O₄ Spinel Polycrystal”; J. Am. Ceram. Soc. 92 (6) 1208-1216 (2009) by Morita et al., but the components described here have an RIT of <70% at a wavelength of 600 nm, so they are not suitable for use as transparent protection. In other words, it has not been possible in the past to combine high-strength values with the required high RIT>75%.

The present invention improves the use options of transparent ceramics under an elevated mechanical load and thus permit more efficient use of these ceramics because thinner components, for example, can be produced and used, but due to their lower breaking tendency, they can fulfill the same function as thicker components with a lower strength. This advantage is especially relevant in use for ballistic protection.

Another important parameter for the quality of a transparent ceramic is the scattering loss in the ceramic. Scattering losses in a ceramic are caused by specks in the ceramic. To minimize scattering losses in ceramics as much as possible, the lowest possible speck frequency is therefore essential. Only in this way is it possible to achieve a corresponding optical quality for numerous possible applications such as optical lenses, safety glass, inspection glass, lasers in the wear-resistant field, etc. If the number of such scattering centers is too high or if the diameters are too large in general, the optical quality of a transparent ceramic is drastically reduced.

For example, with transparent safety glass or wear-resistant glass, this leads to irritation of the driver or plant operator. In other words, this has a negative influence on ergonomics. In the case of lenses, lasers or other precision optical systems, this has a negative influence on performance capability and precision. It is thus absolutely necessary to ensure a certain optical quality.

The causes for such specks/scattering centers may be second phases, caused by chemical contaminants or processing errors.

Thus the object of the invention is to create transparent ceramics having a high strength combined with a high transparency (RIT>75%) and high optical quality.

This object is achieved according to the invention by the features of claim 1. Preferred embodiments and/or refinements of the invention are characterized in the dependent claims.

The object on which the present invention is based has surprisingly been achieved by a ceramic whose average grain size is within a certain range. It has been found that the efficiency of a ceramic in the sense of the present invention can be surprisingly improved if the ceramic material used has average grain sizes in the range of >10 to ≦100 μm, preferably a ceramic material with an average grain size in the range of >10 to 50 μm, especially preferably a ceramic material with an average grain size in the range of >10 to 20 μm, most especially preferably a ceramic material with average grain sizes in the range of 11 to 20 μm, which has a high transparency (RIT>75%) and a high optical quality, instead of a ceramic material with very fine average grain sizes, for example, instead of a ceramic material with an average grain size in the range of <1 μm.

The raw materials to be used according to the invention have an average primary particle size d50 of <2 μm, preferably 5 to 500 nm and a purity of >99.5%, preferably >99.9%, i.e., the highest impurity content is <0.5% or <0.1%, respectively.

Raw materials with a low tendency to agglomerate are especially preferably used according to the invention.

The average grain size is determined according to the intercepted segment method according to DIN EN 623 and the RIT value is determined on a 2-mm-thick polished pane using light with a wavelength of 600 nm.

The high optical quality in the sense of the present invention is characterized by the standard of speck frequency determined according to the method described below. A preferred ceramic material according to the invention has a speck frequency of <10%, while an especially preferred ceramic material according to the invention has a speck frequency of <1%.

Another important aspect of the transparent ceramic is a necessary good polish ability and also a further process ability of the ceramic because this has a definite influence on a large proportion of the total cost. It has surprisingly been found that in the case of a ceramic material according to the invention having average grain sizes in the range of >10 to ≦100 μm, in particular with a ceramic material according to the invention with an average grain size in the range of >10 μm to 20 μm, the hardness of the fine grains, which is crucial for ceramic materials with average grain sizes in the range of <10 μm, cannot be found. The fine grain hardness which is to be used with ceramic materials that have average grain sizes in the range of <10 μm and are known from the prior art interferes not only with the processing of the ceramic but also has a negative effect on the breaking behavior.

This is surprising in as much as the hardness of the ceramic materials according to the invention is lower than that of the ceramics which have finer average grain sizes and are known in the prior art.

Another advantage of the ceramics according to the invention is their particularly good ballistic performance, which has been discovered by gunshot tests in comparison with fine crystalline ceramics (grain size<1 μm). The ballistic advantages of the ceramic materials according to the invention are especially surprising because their hardness is lower but their breaking behavior is better than that of the very fine ceramics known from the prior art (e.g., EP 1 557 402 A2, DE 10 2004 004 259). On the other hand, however, both the hardness and the breaking behavior of the ceramic materials according to the invention are better in comparison with those of the known coarse crystalline ceramics (for example, US 2004/0266605, U.S. Pat. No. 5,001,093, U.S. Pat. No. 4,983,555). In addition, this improves the hardness with respect to multiple shots (multi-hit resistance), i.e., triangle shooting of a transparent ballistic target made of the ceramic material according to the invention.

An average grain size in the range of >10 to ≦100 μm according to the invention, in particular an average grain size in the range of >10 to 50 μm according to the invention also permits optimal processing, easier cutting (e.g., water jet) than is possible with fine crystalline material (lower hardness than fine crystalline material), simplified grinding, polishing in comparison with coarse-grained material (the crystals breaking loose are smaller). This simplified processing allows important degrees of freedom in the later design of any free-form surfaces. This is of particular interest especially in the design of curved panes of glass for protected civil vehicles.

Another advantage of the ceramic material according to the invention is the much more favorable manufacturing cost because coarser powders, which are therefore less expensive, may be used (the average (final) grain size is in the range of >10 to ≦100 μm) and optimal hard processing and more favorable fabrication methods are possible. Since the raw materials make up by far the greatest proportion of the manufacturing cost in a fabrication process that is economical in general, so that through the use of coarser raw materials, it is thus possible to produce a much less expensive product.

The price of the transparent ceramics known from the prior art has so far prevented a more extensive market presence in the field of ballistics. In the past, the extremely high prices have been due either to the hot pressing that was used, since it requires fine nanopowders that are needed for production by other routes, or the extremely complex polishing.

Therefore, the subject matter of the present invention is in detail:
a transparent ceramic with an RIT>75%, measured on a 2-mm-thick polished pane with light of a wavelength of 600 nm with average grain sizes in the range of >10 to ≦100 μm, preferably a transparent ceramic with average grain sizes in the range of >10 to 50 μm, especially preferably a transparent ceramic with an average grain size in the range of >10 to 20 μm, most especially preferably a transparent ceramic with average grain sizes in the range of 11 to 20 μm.

A transparent ceramic containing the following as described above is preferred:
a high optical quality;
a speck frequency of <10%, preferably a speck frequency of <1%;
a second phase whose size is max. <2000 μm, preferably <200 μm;
one of the oxides of zirconium, aluminum, magnesium, yttrium, zinc, tin, calcium, titanium, gallium, indium, hafnium, scandium, cerium, europium, barium or combinations thereof;
Mg—Al spinel, AlON, aluminum oxide, yttrium aluminum garnet, yttrium oxide, zirconium oxide;
AlON;
a spinel ceramic.

The ceramic material according to the invention may be used in ballistics, for example.

The invention is illustrated below on the basis of examples.

### EXAMPLE 1

A spinel powder (MgAl₂O₄) is processed to yield a 50% by weight slip. The low-viscosity slip is then sprayed by means of an eccentric screw pump in a fluidized bed granulation system. Previously the pure powder was fed into the system as the powder bed. Through a gradual and continuous slip feed, the material is granulated continuously and slowly. The pressure conditions and the incoming air are adjusted to produce granules in the size range between d10=100 μm and d90=300 μm. The granules produced in this way are solid granules such as a hollow spherical structure or a doughnut shape that do not have any inhomogeneities. The granules are then pressed uniaxially at 160 MPa to form a sheet with the dimensions 50 mm×50 mm, which can be sintered thoroughly at 1500° C. due to its homogeneity. Then an HIP process is performed, also at 1500° C. and 2000 bar. After the HIP process, the measured density is 3.575 g/cm³, which is determined according to Archimedes' method as in DIN EN 623-2. This represents a density of >99.9%. An RIT value of 83% with 0.2% fluctuation within the sheet thus produced is obtained from the high homogenous density. The speck content present is ≦0.5%. The average grain size of the ceramic determined by the intercepted segment method according DIN EN 623 is 12 μm±0.5 μm after thermal etching of the polished samples.

The ceramic materials produced in this way according to the invention are then analyzed in greater detail by the method described below for speck analysis and are isolated according to the desired specification.

### Method of Speck Analysis

In production of transparent ceramic materials, it has been found that transparent test samples are not formed with most samples but instead all the samples with specks in the size range from a few pm up to several hundred pm are permeated with specks.

This leads to the need for analyzing and quantifying the specks because they have a negative effect on the visual appearance of the part produced later from the ceramic material according to the invention. It is also found that various samples are permeated with these specks to different extents. FIG. 1 shows one such example. FIG. 1 shows a photograph of a sample of pure powder pressed by a cold isostatic method.

On closer examination, many specks look like fissures and/or globular shapes or large pieces. The causes of such defects may be chemical impurities, pressing defects and other processing defects. The macroscopic specks thus occur because of scattering in these areas. There thus seems to be a direct correlation between relics in the greenware, contaminants and the subsequent specks.

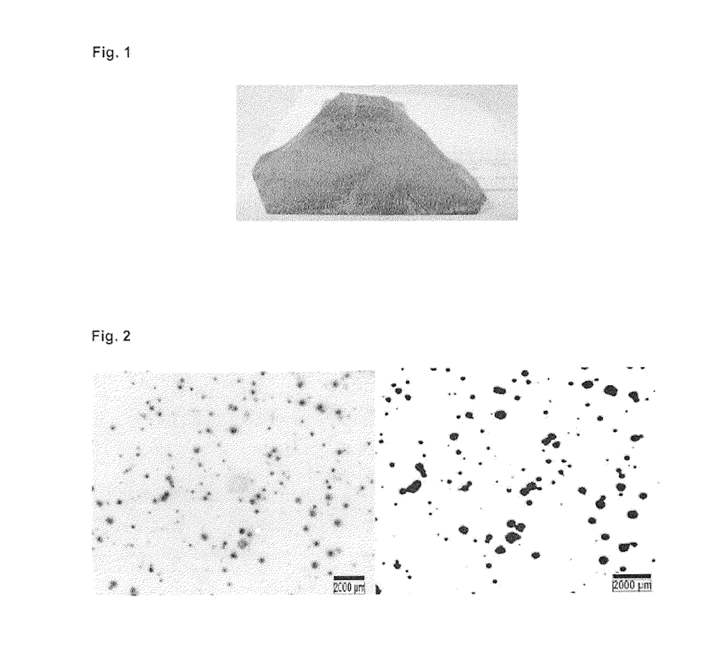

The method described below for speck analysis provides information about the speck size distribution, speck frequency and some of the specks within the sample. Therefore, the middle of the sample and/or the surface of the sample is/are focused in the light microscope and a micrograph is recorded. This image is divided into black and white areas by automated image processing, so that a clear visual difference between specks and transparent areas is discernible. FIG. 2 shows typical images according to microscopic analysis (left) and according to image processing (right) using a 6.3× magnification and an image area of 1280×1024 pixels.

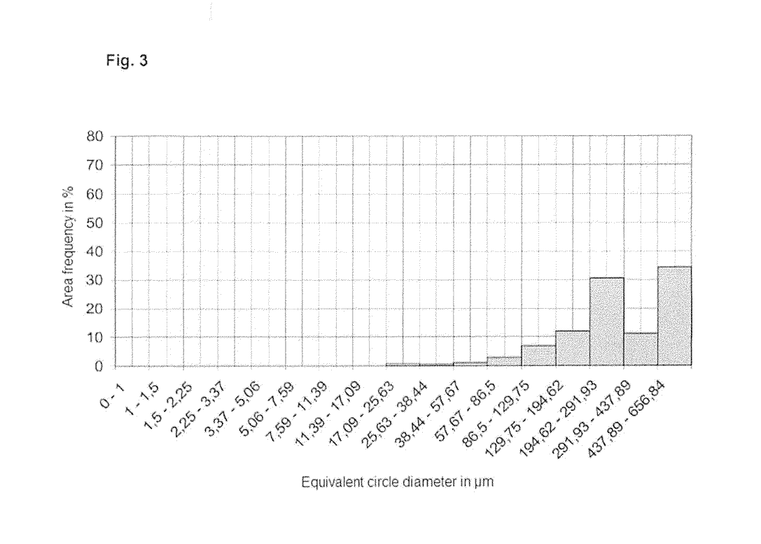

This image is then analyzed by image processing software and an Excel routine with regard to the speck frequency distribution and area content (inclusions as proportion of the total area E_{F}) (FIG. 3). The average inclusion size is E_{D50}. FIG. 3 shows the equivalent diameter of a circle classified in μm on the x axis and the area frequency in % on the y axis. The d50 value in the present case is 281.14 μm, the largest speck has an equivalent circle diameter of 484 μm and an area proportion of 0.44%. The axis factor is 1.5.

The accuracy of the analysis is determined by the resolution (standard 1280×1024 pixels) as well as the defect size and the magnification.

It yields the following for E_{D50}:

E_{D50}=±√(total area)/{(1280×1024)×π}.

With the 63× magnification that is used most commonly, this yields an accuracy of ±0.9 μm for E_{D50}. The area faction is E_{F}±2.72 μm² or ±7.6×10⁻⁵%. Since the procedure has been defined, a high reproducibility of results is ensured, even if the specks disappear due to the image processing in some cases.

1.-11. (canceled)

12. A transparent ceramic having an RIT>75%, measured on a 2-mm-thick polished disk with light of the wavelength of 600 nm, and an average grain size in the range of >10 to ≦100 μm.

13. The transparent ceramic of claim 12, wherein the transparent ceramic has a high optical quality.

14. The transparent ceramic according to claim 12, wherein the average grain size ranges from >10 to 50 μm.

15. The transparent ceramic according to claim 12, wherein the average grain size ranges from >10 to 20 μm.

16. The transparent ceramic according to claim 12 having a speck frequency of <10%.

17. The transparent ceramic according to claim 13, wherein the transparent ceramic comprises a second phase having a maximum size of less than 2000 μm.

18. The transparent ceramic according to claim 12, wherein the ceramic comprises at least one oxide selected from the group consisting of zirconium oxide, aluminum oxide, magnesium oxide, yttrium oxide, zinc oxide, tin oxide, calcium oxide, titanium oxide, gallium oxide, indium oxide, hafnium oxide, scandium oxide, cerium oxide, europium oxide and barium oxide.

19. The transparent ceramic according to claim 12, comprising at least one member selected from the group consisting of Mg—Al spinel, AlON, aluminum oxide, yttrium aluminum garnet, yttrium oxide and zirconium oxide.

20. The transparent ceramic according to claim 12, wherein the transparent ceramic comprises AlON.

21. The transparent ceramic according to claim 12, wherein the transparent ceramic is a spinel ceramic.

22. A method comprising conducting ballistics with the transparent ceramic according to claim 12.
